(19) United States
(12) Patent Application Publication
(10) Pub. No.: US 2006/0251932 A1
(43) Pub. Date: Nov. 9, 2006

(54) Method of reducing delamination

(76) Inventor: Frederick T. Wagner, Fairport, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/122,161

(22) Filed: May 4, 2005

(51) Int. Cl. H01M 8/00; H01M 8/10; F26B 3/00

(52) U.S. Cl. 429/13; 429/30; 34/444

(57) ABSTRACT

A method of reducing freeze-thaw delamination of electrode layers from the electrolyte membranes in a fuel cell is disclosed. The method comprises reducing the water content of the MEA to or below 80 percent of saturation prior to exposing the MEA to freezing conditions. Most preferably the water content of the MEA is reduced to or below about 40 percent of saturation.

### FIELD OF THE INVENTION

The present invention relates to a method for reducing freeze-cycle-caused delamination of the electrode layers from the electrolyte membranes in a PEM fuel cell.

### BACKGROUND OF THE INVENTION

Fuel cells include three primary working components: two electrodes (cathode and anode) and an electrolyte that is sandwiched between the electrodes and passes only protons. Each electrode contains a catalyst layer that contacts the electrolyte. The term “membrane-electrode assembly” (MEA) is used to describe this electrode/membrane/electrode sandwich, with or without (depending on method of production) the two gas diffusion layers on the outside of the electrodes. In operation, the catalyst on the anode splits hydrogen into electrons and protons. The electrons are distributed as electric current from the anode, through a drive motor and then to the cathode. The protons (hydrogen ions) migrate from the anode, through the electrolyte to the cathode. The catalyst on the cathode combines the protons with electrons returning from the drive motor and oxygen from the air to form water. Individual fuel cells can be stacked together in series to generate higher voltages and electric powers.

In a Polymer-Electrolyte-Membrane (PEM) fuel cell, a polymer electrode membrane serves as the electrolyte between a cathode and an anode. The polymer electrolyte membrane currently being used in fuel cell applications requires a certain level of humidity to facilitate conductivity. Therefore, maintaining the proper level of humidity in the membrane, through humidity-water management, is desirable for proper functioning of the fuel cell. Repeated cycling through excessive humidity extremes can cause irreversible damage to the fuel cell.

The presence of liquid water in automotive fuel cells is almost unavoidable because appreciable quantities of water are generated as the product of the electrochemical reactions during fuel cell operation. Furthermore, condensation of liquid water and full saturation of the fuel cell membranes with water can result from rapid changes in temperature, relative humidity, and operating and shutdown conditions. Fuel cell membranes typically absorb more water from direct contact with liquid water than from contact with the vapor in equilibrium with that liquid, a phenomenon known as “Schroeder's paradox”. The maximum amount of water adsorbed by the membrane (or MEA) from the liquid has a weak dependence on the temperature of the water. As used herein “saturation” water content means the mass percent (g water/g dry MEA) of water absorbed (from a dry state) during extended (1-2 hr) contact with liquid water at 80° C., a typical upper temperature limit for PEM fuel cell operation.

Fuel cells are at times exposed to freezing temperatures. Thus the fuel cell goes through freeze/thaw cycles during normal operation. Freezing of water in the fuel cell stack can cause irreversible damage to the fuel cell. One form that this damage can take is delamination of the electrode catalyst layers from the electrolyte membranes. FIG. 2 exemplifies one type of such delamination, in which worm-shaped (vermiform) strips of catalyst peel off of the electrode. Another observed delamination morphology is the popping of small circles (chads) of catalyst off of the membrane. Still another observed morphology is delamination of the electrode over wide (mm- to cm-scale) regions of the membrane. Other delamination morphologies also occur.

Accordingly it would be desirable to provide a method to reduce delamination that can develop when the fuel cell is exposed to freeze/thaw cycles.

### SUMMARY OF THE INVENTION

According to one embodiment of the present invention, there is provided a method of reducing freeze-thaw delamination of electrode layers from the electrolyte membranes in a fuel cell comprising reducing the water content of the MEA to about 80 percent (or less) of its liquid-water-saturated value prior to exposing the MEA to freezing conditions.

### BRIEF DESCRIPTION OF THE DRAWINGS

Advantages of the present invention will be more fully appreciated from the detailed description when considered in connection with accompanying drawings of presently preferred embodiments which are given by way of illustration only and are not limiting wherein:

FIG. 1 is a schematic view of a fuel cell;

FIG. 2 is a microscopic view of a MEA showing significant delamination after 100 freeze-thaw cycles

FIG. 3 is a microscopic view of a MEA dried to lower water content prior to 100 freeze-thaw cycles, showing little if any delamination; and

FIG. 4 is a graph showing test results.

### DETAILED DESCRIPTION OF THE PREFERRED EMBODIMENTS

The following description of the preferred embodiment(s) is merely exemplary in nature and is in no way intended to limit the invention, its application, or uses.

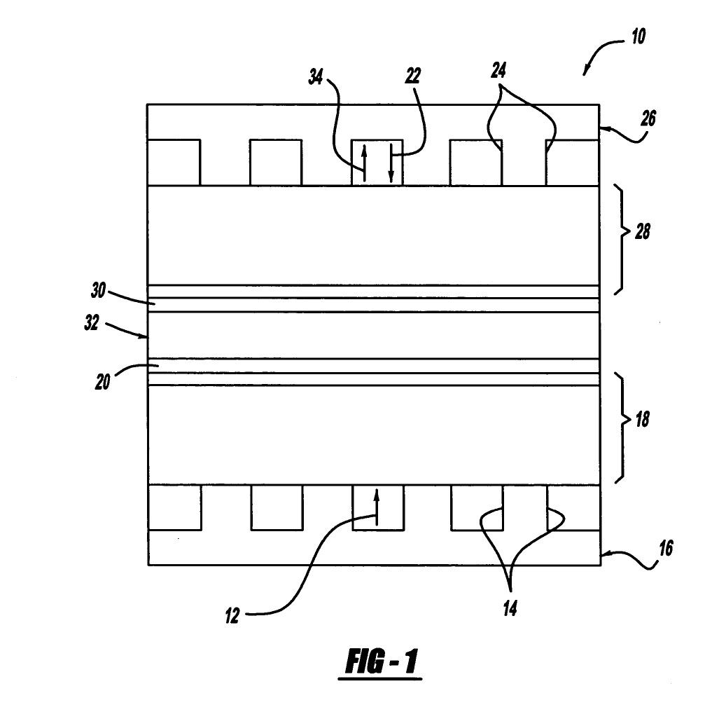

A fuel cell is generally shown at 10 in FIG. 1. During operation of the fuel cell 10, hydrogen gas 12 flows through the field flow channels 14 of a bipolar plate generally indicated at 16 and diffuses through the gas diffusion medium 18 to the anode 20. In like manner, oxygen 22 flows through the field flow channels 24 of the bipolar plate generally indicated at 26 and diffuses through the gas diffusion medium 28 to the cathode 30. At the anode 20, the hydrogen 12 is split in to electrons and protons. The electrons are distributed as electrical current from the anode 20, through a drive motor (not shown) and then to the cathode 30. The protons migrate from the anode 20, through the PEM generally indicated at 32 to the cathode 30. At the cathode 30, the protons are combined with electrons returning from the drive motor (not shown) and oxygen 22 to form water (in vapor and/or liquid form) 34. The water 34 diffuses from the cathode 30 through the gas diffusion medium 28, into the field flow channels 24 of the bipolar plate 26 and is discharged from the fuel cell stack 10.

Thus, it is well known that in a fuel cell stack at the cathode side, the fuel cell generates water in the catalyst layer. The water must leave the electrode. Typically, the water leaves the electrode through the many channels 24 of the element or bipolar plate 26. Typically, air passes through the channels and pushes the water through the channels 24. A problem that arises is that the water creates a slug in the channels 24 and air cannot get to the electrodes. When this occurs, the catalyst layer near the water slug will not work. When a water slug forms, the catalyst layer near the slug becomes ineffective. This condition is sometimes referred to as flooding of the fuel cell. The result of flooding is a voltage drop that creates a low voltage cell in the stack. The flooding can also result in a higher water content in the membrane-electrode assembly (MEA) than would be present if the MEA were in contact with only vapor, making the MEA more susceptible to freeze/thaw delamination.

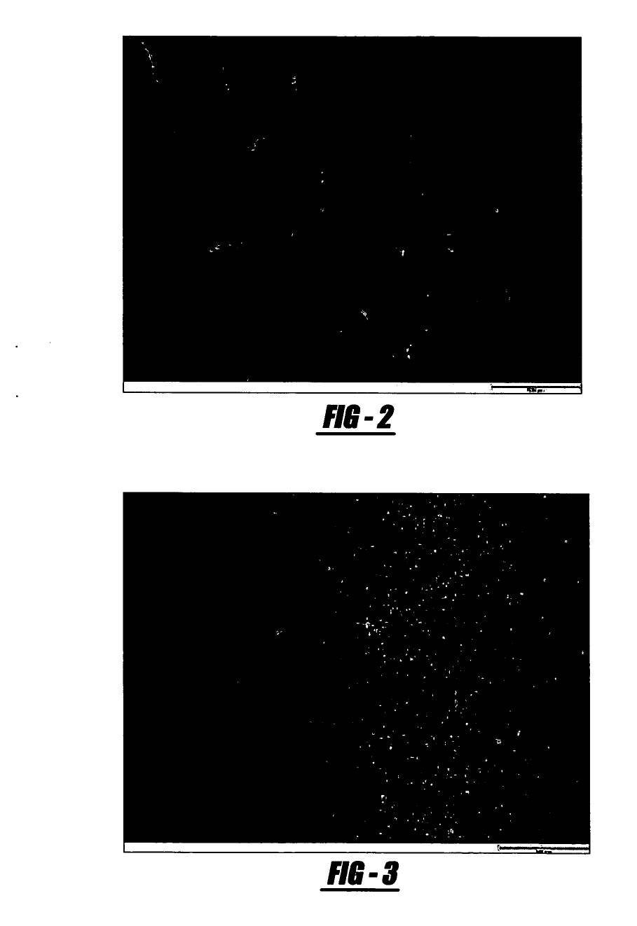

The weight percent of water in the MEA varies with operating conditions including (but not limited to) current density, relative humidity of inlet air and hydrogen, flow rates of air and hydrogen, temperature, pressure, and position of a particular segment of MEA within the stack. The maximum weight percent water in the MEA occurs when the MEA remains in contact with liquid water for extended times, particularly at the high end of the temperature range over which the PEMFC operates (typically 80° C. with common materials including membranes based on perfluorosulfonic acid polymers). For the examples shown in FIGS. 2, 3 and 4, the MEA's picked up about 30 weight percent water when soaked in water at 80° C. for 1-2 hours. As stated above and as used herein, “saturation” water content for any MEA is the weight percent of water absorbed (from a dry state) during extended time (1-2 hr) contact with liquid water at 80° C. The numeric value of the weight percent of water corresponding to saturation water content varies for different types of MEA's (e.g. different layer thicknesses), even for MEA's made with similar materials. Lower water contents can be expressed as “% of saturation”, which is 100% times the ratio of the actual weight percent of water in the MEA to the weight % of water in the same MEA soaked in liquid water at 80° C. It has been found that a reduction of the MEA water content below this saturation value prior to exposure to subfreezing temperatures results in a reduction of delamination of the electrode layers from the electrolyte membranes during freeze-thaw cycles.

According to one preferred embodiment of the present invention, the water saturation level of the MEA is reduced to about 80 percent (or less) of saturation prior to exposing the MEA to freeze/thaw cycles. It more preferable to reduce the water saturation level to or below about 50 percent saturation prior to exposing the MEA to freeze/thaw cycles. The amount of reduction in saturation required to reduce delamination is also related to the lower temperature limit that the MEA will see. That is, lower MEA water contents are needed to provide protection against delamination when the temperature reduces to still-lower subfreezing temperatures, as will be detailed below.

FIGS. 2 and 3 show MEAs that were exposed to testing. Each of the MEAs was saturated with water by immersing it in deionized water at 80°° C. for 1 to 2 hours. The MEAs were removed from the water bath, quickly blotted dry between lint-free cloths to remove surface water, and weighed. The saturated MEAs picked up about a 30 percent weight gain due to the absorbed water. The MEAs were then allowed to dry to 75 percent (FIG. 2) and 50 percent (FIG. 3) of this initial saturation water content while sitting on an analytical balance. Once the MEAs reached the respective water contents, they were quickly taken from the balance and heat-sealed into vapor-barrier bags. The bagged MEAs were then subjected to 100 freeze/thaw cycles over a temperature range of −40° C. to 80° C. in a programmable environmental chamber. The samples were removed from the bags while still moist and examined under an optical stereomicroscope equipped with a digital camera. Representative samples are shown in FIGS. 2 and 3, respectively.

FIG. 2 shows vermiform delamination of the electrode layers from the electrolyte membranes that occurred in the 75 percent saturated sample. The delaminations appear as worm-shaped strips of the catalyst layer peeled off from the underlying membrane. Delaminated strips of catalyst were observed inside the barrier bag from which the still-moist sample was removed. This observation shows that the delamination occurred during freeze-thaw cycling, not during subsequent drying and shrinking of the MEA after it was removed from the vapor-barrier bag.

FIG. 3 shows that no vermiform (or other form of) delamination of the electrode layers from the electrolyte membranes occurred in the 50 percent saturated sample. Accordingly, the 50 percent saturation sample indicates that reducing the water content down to at most 50% of saturation significantly reduces delamination of the electrode layers from the electrolyte membranes when the sample is exposed to freeze temperatures as low as −40° C.

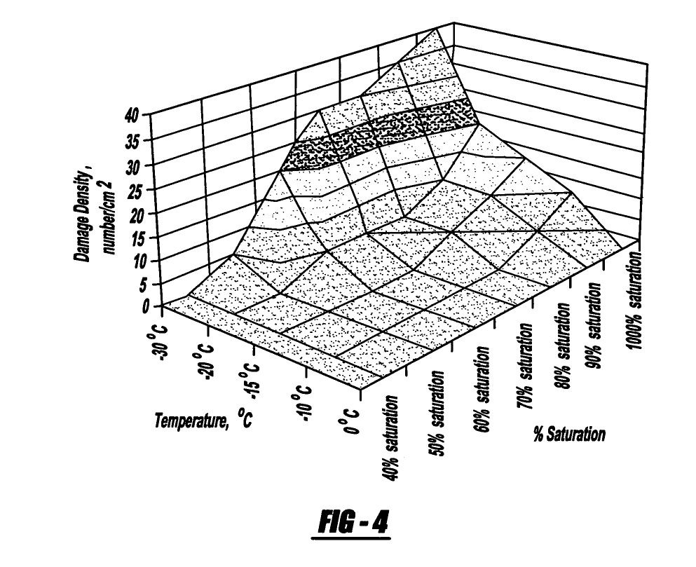

It has been found that the lowest temperature of the freeze/thaw cycle to which the MEA is exposed affects the water content that induces delamination of the electrode layers from the electrolyte membranes. FIG. 4 is a graph showing test results. The samples were prepared as above. The graph of FIG. 4 is 3-dimensional and plots damage density versus temperature and % of saturation water content. The damage density is quantified by counting the individual worms, chads or other visual evidence of local delamination per cm² of MEA. The results shown in FIG. 4 are based on 20 freeze-thaw cycles of each sample.

The graph of FIG. 4 shows that at freeze temperatures of down to −10° C. a reduction to about 80 percent of saturation water content of the MEA results in significant reduction in delamination of the electrode layers from the electrolyte membranes. Further, a reduction to about 70 percent of saturation water content of the MEA results in significant reduction in delamination of the electrode layers from the electrolyte membranes at temperatures of at least as low as about −20° C. Also, at freeze temperatures of down to −30° C. a reduction to about 50 percent of saturation water content of the MEA results in significant reduction in delamination of the electrode layers from the electrolyte membranes. As shown in FIG. 4, a reduction to about 40 percent saturation significantly reduces visible delamination of the electrode layers from the electrolyte membranes at temperatures at least as low as −30° C.

Without being bound to any specific theory, it is hypothesized that the particular mechanism for the delamination is the freezing of water that concentrates in preexisting mudcracks in the catalyst layer. Accordingly, by reducing the amount of water that concentrates on the catalyst layer there is a reduction in the delamination during the freeze cycles.

In order to reduce the water content of an MEA in operation in a vehicle, for example, dry air can be passed over the MEA prior to exposure of the fuel cell to freezing temperatures. This dry air will pick up water from the MEA, purge it to the atmosphere and thereby reduce the saturation level of the MEA. One method by which this can be accomplished as follows. To reduce the water content of the MEA to 50 percent of saturation, for example, at which point it still has about 50 percent of its saturation hydrogen-ion conductivity and could still produce some power, the fuel cell is operated with low inlet gas humidification prior to shutdown. Another method by which the saturation level can be reduced is by purging with dry air and/or hydrogen after shutdown. Either of these methods is acceptable singly or could be used together. This purge procedure could be initiated any time that an outside air temperature sensor indicated a temperature below or near freezing. It will be appreciated, however, that any manner of reducing the saturation level of water of the MEA is contemplated within the context of the present invention. Further, it will be appreciated that the MEA water content may be reduced to any desirable level. If necessary, the MEA water content could be measured by its effect on membrane ionic conductance quantified, for example, as the inverse of the electrical impedance of a cell measured at 1 kHz.

Accordingly, one presently preferred method of the present invention is to reduce the MEA water content to or less than about 80 percent of saturation prior to exposing the fuel cell to freezing temperatures. More preferably, the water content of the MEA is reduced to or less than about 50 percent of saturation. And even more preferably, the water content of the MEA is reduced to or less than about 40 percent of saturation prior to shutdown of the fuel cell. Higher MEA water contents, of up to about 80 percent of saturation, are acceptable when the temperature does not go below −10° C. However, at lower freeze temperatures, below about −30° C., it is preferred that the MEA water be reduced to or less than about 50 percent and more preferably to or less than about 40 percent of saturation.

The invention has been described in an illustrative manner, and it is to be understood that terminology which has been used is intended to be in the nature of words of description, rather than of limitation. Many modifications and variations of the present invention are possible in light of the above teachings.

It is, therefore, to be understood that the invention may be practiced other that as specifically described within the scope of the appended claims.

What is claimed is:

1. A method of reducing freeze-thaw delamination of electrode layers from the electrolyte membranes in a fuel cell comprising reducing the water content of the MEA to or less than about 80 percent of saturation prior to exposing the MEA to freezing conditions.

2. A method as set forth in claim 1 wherein the water content of the MEA is reduced to or less than about 70 percent of saturation.

3. A method as set forth in claim 1 wherein the water content of the MEA is reduced to or less than about 50 percent of saturation.

4. A method as set forth in claim 1 wherein the water content of the MEA is reduced to or less than about 40 percent of saturation.

5. A method as set forth in claim 1 wherein the water content of the MEA is reduced by operating the fuel cell at low inlet gas humidification prior to shutdown of the fuel cell.

6. A method as set forth in claim 1 wherein the water content of the MEA is reduced by purging the MEA with dry gas after shutdown of the fuel cell.

7. A method as set forth in claim 6 wherein the gas is selected from the group comprising air, hydrogen and mixtures thereof.

8. A method as set forth in claim 1 further comprising measuring the water content of the MEA.

9. A method as set forth in claim 8 wherein the water content of the MEA is determined by quantifying the membrane ionic conductance.

10. A method as set forth in claim 1 wherein the water content of the MEA is reduced to or less than about 80 percent of saturation when the temperature is to be reduced to not below −10° C.

11. A method as set forth in claim 2 wherein the water content of the MEA is reduced to or less than about 70 percent of saturation when the temperature is to be reduced to not below about −20° C.

12. A method as set forth in claim 3 wherein the water content of the MEA is reduced to or less than about 50 percent of saturation when the temperature is to be reduced to not below about −30° C.

13. A method as set forth in claim 3 wherein the water content of the water of the MEA is reduced to or less than about 40 percent of saturation when the temperature is reduced to below about −30° C.
